(19) United States
(12) Patent Application Publication
(10) Pub. No.: US 2010/0161340 A1
(43) Pub. Date: Jun. 24, 2010

(54) Dynamic Codec Switching

(75) Inventors: Scott Walsh, Foxham (GB); Richard Winter, Bristol (GB); Peter K. Reid, Marlborough (GB)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/343,827

(22) Filed: Dec. 24, 2008

(51) Int. Cl. G10L 19/00

(52) U.S. Cl. 704/500; 704/E19.001

(57) ABSTRACT

In one embodiment, a method and apparatus for processing an audio signal are provided. In one example of the invention, an audio signal is received. The audio signal is analyzed to determine an interference level of the audio signal relative to a threshold interference level. Then the audio signal is processed with a lower quality codec or a higher quality codec responsive to the determination of the interference level of the audio signal relative to the threshold interference level.

### BACKGROUND

Modern headsets can now use various coding/decoding (codec) methods, such as pulse code modulation (PSM) or continuously variable slope delta modulation (CVSD), to encode a digital data stream or signal as a representation of an analog signal and to decode the signal for use such as viewing, listening, or editing. In one example, a high quality codec, such as PSM, involves sampling the magnitude of the signal at uniform intervals and then quantizing the samples to a series of symbols in a numeric (usually binary) code. A lower quality codec, such as CVSD, involves a delta modulation with variable step size and encodes at 1 bit per sample, in one example.

Higher quality codecs are primarily used for office applications (e.g., headsets connected to a base) but higher quality codecs tend to be more susceptible to radio interference than lower quality codecs. The audio device user is likely to hear “clicks” and/or “pops” under interference conditions and/or when nearing radio range limits.

Thus, systems, apparatus, and methods for coding/decoding a digital audio signal with an improved audio quality are desirable.

### DESCRIPTION OF THE DRAWINGS

The features and advantages of the apparatus and method of the present invention will be apparent from the following description in which:

FIG. 1 is a flowchart illustrating the operation of the invention in one example;

FIG. 2 illustrates an example of the hardware architecture in one example of the invention; and

FIG. 3 illustrates a headset amplifier application in one example of the invention.

### DETAILED DESCRIPTION

The present invention discloses an inventive method and apparatus for providing dynamic and automatic coding/decoding (codec) switching thereby reducing interference for audio signal output while increasing wireless signal range.

Other embodiments of the present invention will become apparent to those skilled in the art from the following detailed description, wherein is shown and described only the embodiments of the invention by way of illustration contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive. The data structures and code described in this detailed description are typically stored on a computer readable storage medium, which may be any device or medium that can store code and/or data for use by a computer system. Furthermore, although software code or components are described in certain instances, those skilled in the art will recognize that such may be equivalently replaced by firmware and hardware components. For purpose of clarity, details relating to technical material that is known in the technical fields related to the invention have not been described in detail so as not to unnecessarily obscure the present invention.

The present invention provides a method and apparatus for processing an audio signal. The method and apparatus may be used in systems such as those that play sound via an audio device located close to the listener's ear or via a loudspeaker or other transducer located distant from the listener.

In one example of the invention, an audio signal is received. The quality or interference level of the audio signal is determined relative to a threshold interference level. The audio signal is then processed responsive to whether the audio signal has an interference level above the threshold interference level or within a threshold interference range. Interference threshold levels or ranges may be pre-determined based upon empirical tests for telephone-grade audio, music, digital audio from a personal computer, and so on. If the audio signal is classified to have an interference level above a threshold (or within a range) the signal processing includes a lower quality codec signal processing, such as CSVD, which is more resilient to interference. If the audio signal is classified/determined to not have an interference level above a threshold, the signal processing includes a higher quality codec signal processing, such as PCM.

The present invention dynamically and automatically reduces the potential for interference while increasing listening quality and range. The signal processing performed on the audio signal (i.e., utilizing a particular codec) is automatically selected invisibly to the user based on the determined interference level of the audio signal relative to a threshold interference level. In one example, the audio signal quality or interference level is continuously monitored, and when using the lower quality codec, a determination can be made when the audio signal quality or interference level is sufficiently below threshold levels to switch back to a higher quality codec. Advantageously, when a lower quality codec is determined to be needed, such as for an interference level above a threshold, a lower quality codec is utilized to reduce interference and provide a higher listening quality while increasing wireless signal range, but when a higher quality mode is determined to be beneficial, such as for an interference level below a threshold, a higher quality codec is automatically utilized to provide higher listening quality.

In one application of the invention, the determination of the signal quality/interference level and signal processing occurs within a headset amplifier. In this application, the headset amplifier and associated headset may be used with any electronic device where audio may be output. In a further application of the invention, the determination and signal processing of the present invention is performed within a host personal computer or mobile computing device, such as in voice over Internet Protocol (VoIP) applications where the headset is directly connected to the personal computer or mobile computing device. In yet a further application of the invention, the determination and signal processing of the present invention is performed within a headset.

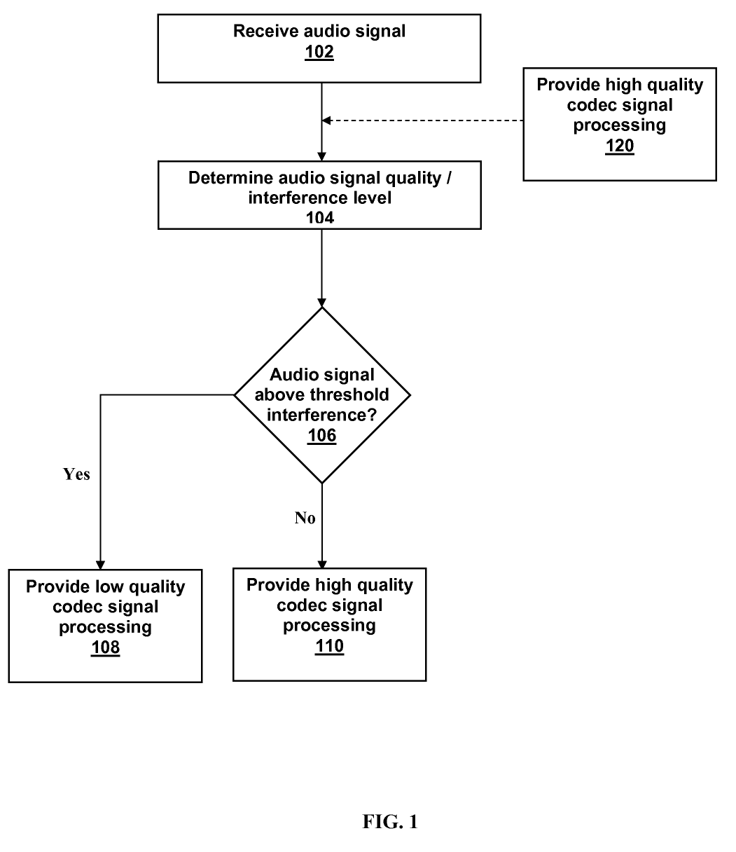

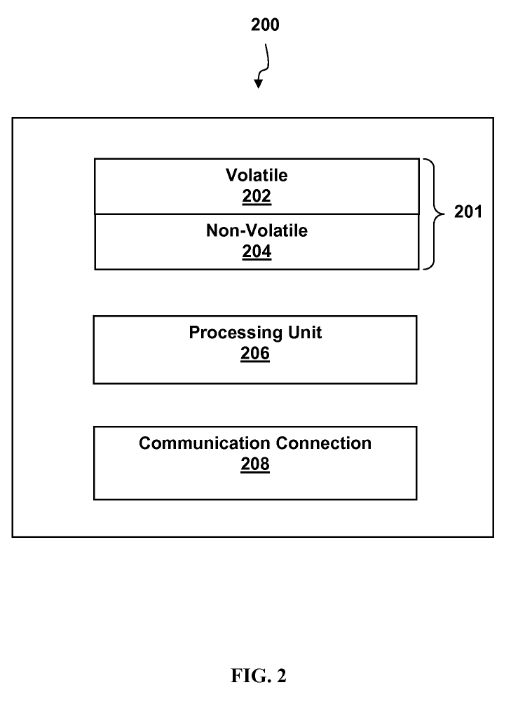

FIG. 1 is a flow chart illustrating the operation of the invention in one example of the invention. At block 102, an audio signal is received for processing (e.g., at a communication connection of system 200 (FIG. 2) or a headset network interface). At block 104, an audio signal quality or interference level of the audio signal is determined (e.g., by a processor). At block 106, the determined audio signal quality or interference level is examined relative to a threshold interference level, and in one example is determined or classified whether the signal quality or signal interference level is above the threshold interference level or within a threshold interference range. If yes, a lower quality codec signal processing is performed on the signal at block 108, and the audio signal is output to the user. If no (e.g., at or below the threshold level or outside of a threshold range), a higher quality codec signal processing is performed on the signal at block 110, and the audio signal is output to the user. A received audio signal may be continuously monitored, with the default setting that the audio signal is processed with a higher quality codec in one example, as shown by block 120. In other embodiments, the default setting may be that the audio signal is processed with a lower quality codec. In one example, the default codec setting, the threshold interference level, and/or the threshold interference range may be determined and changed based upon the audio signal source or audio type if that information is available (e.g., a higher quality codec could be utilized for audio from a computer or for music). Various audio signal sources may be determined and classified for high quality or low quality codec processing. Additional signal processing may also be performed on the audio signal after the codec signal processing.

The determination or classification of the audio signal quality or interference level at block 104 may be performed using a variety of signal processing techniques. In one example, spectral analysis is used. A fast Fourier transform DSP algorithm analyzes the audio signal received by the amplifier in different frequency bands. For example, the signal may be analyzed in half octave frequency bands. From this analysis, the spectral

[symbol]

Once the interference level determination or classification is made, the switch between meeting and not meeting the threshold interference level (or the switch between different codecs) occurs with a time and hysteresis factor built in that prevents undesirable hunting between the two states. The switching characteristic may have a soft transition so as not to be noticeable to the user except in that the benefits of this invention results in reduced interference and increased range.

Referring now to FIG. 2, one example system 200 for implementing the processes set forth in FIG. 1 is shown. The system 200 typically includes at least one processing unit 206 and memory 201. Processing unit 206 interfaces with memory 201 and a communication connection 208 to receive and send audio to and from other devices. Processing unit 206 processes information and instructions used by system 200 to execute audio signal analysis and processing as described above with reference to FIG. 1 to provide automatic and dynamic codec switching. Memory 201 is any type of memory that can be used to store code and data for processing unit 206, and in one example includes a codec library having at least a lower quality codec and a higher quality codec for lower and higher quality signal processing. Depending on the exact configuration and type of device system 200 which is implemented, memory 201 may include volatile memory 202 (such as RAM), non-volatile memory 204 (such as ROM, flash memory, etc.) or some combination of the two. By way of example, and not limitation, the communication connection 208 may include wired media such as a direct-wired connection, and wireless media such as an RF link.

The device on which system 200 is implemented may have a variety of features and functionality. The implementation device may utilize several forms of computer storage media. Depending on the particular device, the computer storage media may include volatile and nonvolatile, removable and non-removable media implemented in any method or technology for storage of information such as computer readable instructions, data structures, program modules or other data. Memory 201 may be incorporated or integrated with the computer storage media of the implementation device. Computer storage media includes, but is not limited to, RAM, ROM, EEPROM, flash memory or other memory technology. Where the implementation device is a personal computer, the computer storage media includes CD-ROM, digital versatile disks (DVD) or other optical storage, magnetic cassettes, magnetic tape, magnetic disk storage or other magnetic storage devices, or any other medium which can be used to store the desired information and which can accessed by the implementation device on which system 200 is implemented.

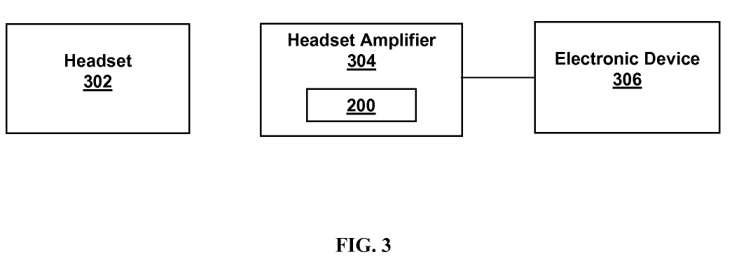

For example, referring to FIG. 3, system 200 may be implemented on a headset amplifier 304. By implementing system 200 at a headset amplifier 304, system 200 is independent of the electronic device to which it is attached and can therefore be used with a variety of electronic devices. The headset amplifier 304 may have multiple inputs to accommodate multiple devices simultaneously. Processing power at headset amplifier 304 may advantageously be higher than other components. In a further example, system 200 may be implemented on a desktop or laptop personal computer, mobile handset, personal digital assistant, wired or wireless headset, or sound card. Although described independently here, processing unit 206 and memory 201 typically already reside on the device to perform other functions associated with the device. Thus, implementation of processing set forth in FIG. 1 may not require additional hardware resources.

In one application, a headset 302 is couplable (via a wired or wireless connection) to a headset amplifier 304 which, in turn, is connected to an electronic device 306. For example, the electronic device 306 may be a telephone, digital music player, PDA, or an integrated device combining functionality of two or more of such devices. The headset 302 includes at least one speaker and a microphone and may be wired or wireless.

The headset amplifier 304 is generally used to amplify signals to or from electronic device 306. In one application, the headset amplifier 304 receives the audio signal from electronic device 306, determines an audio quality or interference level for the signal, and provides a power output to drive the speaker of the headset 306. The headset amplifier 304 may provide power for the headset microphone, receives the audio signal from the microphone, and modifies the audio signal from the microphone. Typically, an electret microphone is used, which requires that headset amplifier 304 supply DC power of a few volts at between 15 and several hundred microamps to a wired headset 302.

In the present example, headset amplifier 304 includes system 200 for performing digital signal processing on the audio signal in addition to amplification. The headset amplifier 304 may provide automatic and dynamic codec switching dependent on at least the audio signal quality or interference level in order to provide higher listening quality, reduced interference, and/or increased range as described above with respect to FIGS. 1 and 2.

Headset amplifier 304 may receive power from a variety of sources. For example, it may draw current from electronic device 306. Headset amplifier 304 may also be powered with a battery or from power derived from the USB port of a PC or from an AC wall outlet using a DC power supply.

Although a headset has been mentioned in this embodiment, the systems and methods described herein may be utilized for various audio devices located close to the listener's ear such as a headset, handset, mobile phone, headphone, or earphone, as well as audio devices located at a distance to the listener's ear such as loudspeakers or other transducers located distant from the listener.

For the case in which system 200 is implemented within headset 302 or another audio device located close to the listener's ear and requiring a battery (such as for a wireless headset), battery life is advantageously increased and interference is advantageously decreased with the automatic and dynamic codec switching of the present invention.

A headset processor may allow for processing data, in particular managing signals between an audio source and acoustic transducers. The processor may also process information for network interfacing, such as for access points, service providers, and service accounts, and also for call functions such as for volume control, muting, and call information. In one example, the headset processor is a high performance, highly integrated, and highly flexible system-on-chip (SOC), including signal processing functionality such as echo cancellation/reduction and gain control in another example. The processor may include a variety of processors (e.g., digital signal processors) with conventional CPUs being applicable.

A headset network interface may allow for communications with access points (APs), and in one example includes a transceiver for communicating with a wireless local area network (LAN) radio transceiver (e.g., wireless fidelity (WiFi), Bluetooth, ultra wideband (UWB) radio, etc.) for access to a network (e.g., a wireless LAN or the Internet), or an adaptor for providing wired communications to a network. In one example, the network interface is adapted to derive a network address for the headset using the headset's electronic serial number, which is used to identify the headset on the network. In one embodiment, the electronic serial number may be the headset's Media Access Control (MAC) address; however, the electronic serial number may be any number that is mappable to a network address. The network interface is adapted to communicate over the network using the network address that it derives for the headset, and in one embodiment, the network interface is able to transmit and receive digital and/or analog signals, and in one example communicates over the network using IP, wherein the network interface uses the headset's MAC address or another globally unique address as its IP address. In particular, the network interface may be operably coupled to a network via the IEEE 802.11 protocol. However, the network interface may communicate using any of various protocols known in the art for wireless or wired connectivity.

An example of an applicable network interface and the Internet protocol layers (and other protocols) of interest for the present invention are described in pending U.S. patent application Ser. No. 10/091,905 filed Mar. 4, 2002, the full disclosure of which is hereby incorporated by reference for all purposes.

A headset transducer may include a microphone, a speaker, or a combination thereof, for transmission of sound (such as from the user's mouth or to the user's ear based upon signals from an audio source). The transducer may also include a plurality of separate transducers for performing different functions. The transducer can be any type of electromagnetic, piezoelectric, or electrostatic type of driving element, or a combination thereof, or another form of driving element, for generating sound waves from the output face of the transducer. In one embodiment, the transducer may receive signals through wireless communication channels, such as by Bluetooth™ protocols and hardware, in one example.

A headset memory may include a variety of memories, and in one example includes SDRM, ROM, flash memory, or a combination thereof. The memory may further include separate memory structures or a single integrated memory structure. In one example, the memory may be used to store passwords, network and telecommunications programs, an operating system (OS), a signal interference/quality analysis engine, and a codec library including at least a lower quality codec and a higher quality codec.

The headset may further include hardware, software, and/or firmware to provide common headset functionality such as volume control (which can include circuitry coupled to the speaker wires for allowing the user to control the gain of acoustic signals being sent to the transducers), mute control (which can include circuitry coupled to the speaker wires for allowing the user to mute acoustic signals being sent to the transducers), and power/call functionality (which can include a printed circuit board operably embedded into the headset body and operably connected in line with the speaker wires to allow for quick access and actuation of the answer/end call function and powering on and off of the headset).

It is further noted that system 200 may also be implemented within electronic device 306, such as a PC.

While the embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A method for processing an audio signal, the method comprising:
receiving an audio signal;
determining an interference level of the audio signal relative to a threshold interference level; and
processing the audio signal with a lower quality codec or a higher quality codec responsive to the determination of the interference level of the audio signal relative to the threshold interference level.

2. The method of claim 1, wherein the audio signal is received at one of a headset, a headset amplifier, and a personal computer.

3. The method of claim 1, wherein determining the interference level of the audio signal comprises analyzing the audio signal in different frequency bands and comparing a spectral power density of different bands.

4. The method of claim 1, further comprising switching between a higher quality codec and a lower quality codec at a predetermined threshold having a built in hysteresis factor.

5. The method of claim 1, wherein the audio signal is processed with a higher quality codec if the audio signal is determined to have an interference level at or below the threshold interference level and a lower quality codec if the audio signal is determined to have an interference level above the threshold interference level.

6. The method of claim 1, wherein the higher quality codec is a pulse code modulation (PCM) codec and the lower quality codec is a continuously variable slope delta modulation (CVSD) codec.

7. The method of claim 1, further comprising continuously monitoring a received audio signal for an interference level relative to a threshold interference level.

8. A computer readable storage medium storing instructions that when executed by a computer cause the computer to perform a method for processing an audio signal, comprising:
receiving an audio signal;
determining an interference level of the audio signal relative to a threshold interference level; and
processing the audio signal with a lower quality codec or a higher quality codec responsive to the determination of the interference level of the audio signal relative to the threshold interference level.

9. The computer readable storage medium of claim 8, wherein determining the interference level of the audio signal comprises analyzing the audio signal in different frequency bands and comparing a spectral power density of different bands.

10. The computer readable storage medium of claim 8, wherein the method for processing an audio signal further comprises switching between a higher quality codec and a lower quality codec at a predetermined threshold having a built in hysteresis factor.

11. The computer readable storage medium of claim 8 wherein the audio signal is processed with a higher quality codec if the audio signal is determined to have an interference level at or below the threshold interference level and a lower quality codec if the audio signal is determined to have an interference level above a threshold interference level.

12. The computer readable storage medium of claim 8, wherein the higher quality codec is a pulse code modulation (PCM) codec and the lower quality codec is a continuously variable slope delta modulation (CVSD) codec.

13. The computer readable storage medium of claim 8, wherein the method for processing an audio signal further comprises continuously monitoring a received audio signal for an interference level relative to a threshold interference level.

14. An apparatus for processing an audio signal comprising:
a receiving mechanism for receiving an audio signal;
a classifying processor for determining an interference level of the audio signal relative to a threshold interference level; and
a signal processor for processing the audio signal with a lower quality codec or a higher quality codec responsive to the determination of the interference level of the audio signal relative to the threshold interference level.

15. The apparatus of claim 14, wherein the receiving mechanism is at one of a headset, a headset amplifier, and a personal computer.

16. The apparatus of claim 14, wherein the classifying processor is configured to analyze the audio signal in different frequency bands and compare a spectral power density of different bands.

17. The apparatus of claim 14, wherein the classifying processor is configured to switch between a higher quality codec classification and a lower quality codec classification at a predetermined threshold having a built in hysteresis factor.

18. The apparatus of claim 14, wherein the signal processor is configured to process the audio signal with a higher quality codec if the audio signal is determined to have an interference level at or below the threshold interference level and a lower quality codec if the audio signal is determined to have an interference level above a threshold interference level.

19. The apparatus of claim 14, wherein the higher quality codec is a pulse code modulation (PCM) codec and the lower quality codec is a continuously variable slope delta modulation (CVSD) codec.
